(19) United States
(12) Patent Application Publication
(10) Pub. No.: US 2015/0267781 A1
(43) Pub. Date: Sep. 24, 2015

(54) Multi Speed Transmission

(71) Applicant: CATERPILLAR INC., Peoria, IL (US)

(72) Inventors: Kevin G. Meyer, Germantown Hills, IL (US); James S. Rice, Deer Creek, IL (US)

(73) Assignee: CATERPILLAR INC., Peoria, IL (US)

(21) Appl. No.: 14/218,118

(22) Filed: Mar. 18, 2014

(51) Int. Cl. F16H 3/66

(52) U.S. Cl. CPC F16H 3/66; F16H 2200/0069; F16H 2200/0082; F16H 2200/2012; F16H 2200/2046; F16H 2003/447

(57) ABSTRACT

A multi-speed transmission includes a housing; an input member and an output member; four planetary gear trains including a first planetary gear train, a second planetary gear train, a third planetary gear train and a fourth planetary gear train, wherein each of the planetary gear trains includes a ring gear, a planetary carrier and a sun gear; and six control elements. Each of the six control elements is operatively connected to at least one of the planetary gear trains and selectively engageable to produce a set of different speeds between the input member and the output member. The set of different speeds includes ten forward speeds and two reverse speeds.

### TECHNICAL FIELD

This disclosure relates generally to multi-speed transmissions used in vehicles and machines, and more particularly to planetary multi-speed transmission systems.

### BACKGROUND

Generally, a machine such as a vehicle, construction equipment, a mining machine, and the like is equipped with a transmission. The transmission may allow the machine to work at several different speeds so that the machine can perform various tasks effectively. Typically, the transmission includes a series of gears which are arranged to generate a certain range of speed.

US Publication 2013-0072343 (US'343) to Shim discloses a transmission having four planetary gears with rotating and fixed clutches. The transmission in the US'343 is configured to produce eleven forward and three reverse gear ratios. However, considering the various operation conditions of the machine, it is desirable to develop a transmission that can be adaptively configured to various speed and torque combinations.

### SUMMARY

The disclosure describes, in one embodiment, a multi-speed transmission including: a housing; an input member and an output member; four planetary gear trains including a first planetary gear train, a second planetary gear train, a third planetary gear train and a fourth planetary gear train, where each of the planetary gear trains includes a ring gear, a planetary carrier and a sun gear; and six control elements. Each of the six control elements is operatively connected to at least one of the planetary gear trains and selectively engageable to produce a set of different speeds between the input member and the output member. The set of different speeds includes ten forward speeds and two reverse speeds. The third planetary gear train is connected to the input member.

In another embodiment, the disclosure describes a multi-speed transmission including: a housing; an input member and an output member; four planetary gear trains including a first planetary gear train, a second planetary gear train, a third planetary gear train and a fourth planetary gear train where each of the planetary gear trains includes a ring gear, a planetary carrier and a sun gear, and where at least one planetary carrier in the transmission is a double-orbit planetary carrier; and six control elements. Each of the control elements is operatively connected to at least one of the planetary gear trains and selectively engageable to produce a set of different speeds between the input member and the output member. The set of different speeds includes ten forward speeds and two reverse speeds. The third planetary gear train is connected to the input member.

In another embodiment, the disclosure describes a multi-speed transmission including: a housing; an input member and an output member; four planetary gear trains including a first planetary gear train, a second planetary gear train, a third planetary gear train and a fourth planetary gear train where each of the planetary gear trains includes a ring gear, a planetary carrier and a sun gear, and where at least one planetary carrier in the transmission is a double-orbit planetary carrier; and no more than six control elements. Each of the control elements is operatively connected to at least one of the planetary gear trains and selectively engageable to produce a set of different speeds between the input member and the output member. The set of different speeds includes ten forward speeds and two reverse speeds. The output member is connected the fourth planetary gear train.

### BRIEF DESCRIPTION OF THE DRAWINGS

FIG. 1 is a schematic illustration of an exemplary planetary multi-speed transmission system in accordance with an embodiment of the disclosure.

FIG. 2 is a truth table identifying the engaged control elements, ratio reductions, and step ratios for each gear provided by the system of FIG. 1.

FIG. 3 is a schematic illustration of an exemplary planetary multi-speed transmission system in accordance with another embodiment of the disclosure.

FIG. 4 is a truth table identifying the engaged control elements, ratio reductions, and step ratios for each gear provided by the system of FIG. 3.

FIG. 5 is a schematic illustration of an exemplary planetary multi-speed transmission system in accordance with another embodiment of the disclosure.

FIG. 6 is a truth table identifying the engaged control elements, ratio reductions, and step ratios for each gear provided by the system of FIG. 5.

FIG. 7 is a schematic illustration of an exemplary planetary multi-speed transmission system in accordance with another embodiment of the disclosure.

FIG. 8 is a truth table identifying the engaged control elements, ratio reductions, and step ratios for each gear provided by the system of FIG. 7.

### DETAILED DESCRIPTION

The disclosure relates to a planetary multi-speed transmission system. The system may include a plurality of planetary gear trains and a plurality of selectively engageable torque transmitting mechanisms or control elements and may provide at least ten forward and at least one reverse speeds or gear ratios. As used herein, the term “control element” may include clutches (which are alternatively referred to in the industry as rotational clutches), brakes (which are alternatively referred to in the industry as stationary clutches) or other torque control components that may conventionally be used in a transmission.

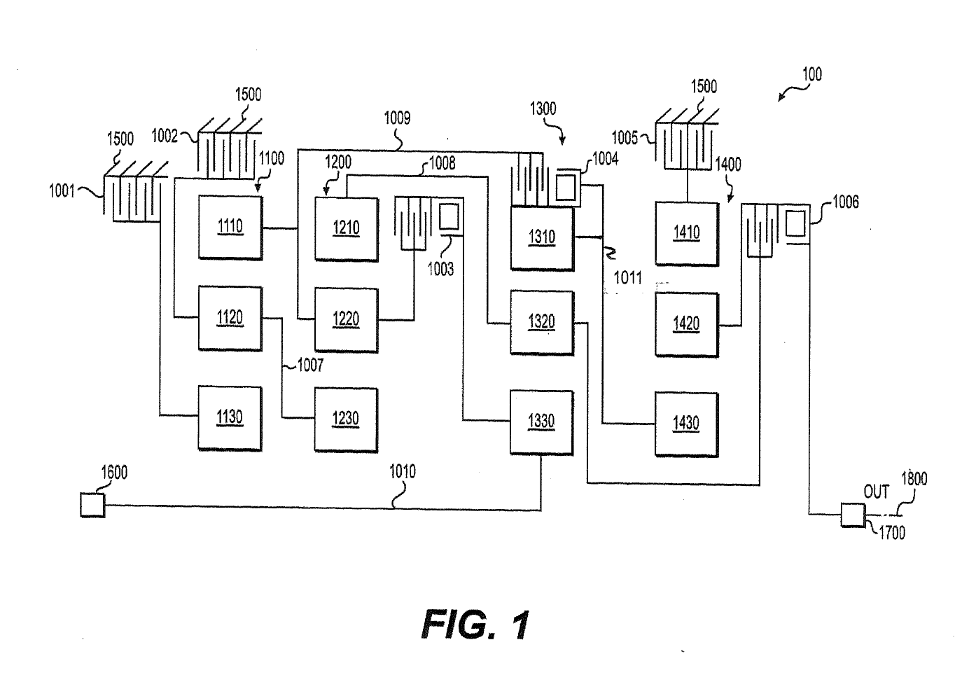

An embodiment of the planetary multi-speed transmission system 100 is illustrated in FIG. 1. The system 100 may include four planetary gear trains 1100, 1200, 1300, 1400, which are arranged in sequential order in an axial direction or the direction of power flow along axis 1800. The first planetary gear train 1100 may include a first ring gear 1110, a first planetary carrier 1120 and a first sun gear 1130. The second planetary gear train 1200 may include a second ring gear 1210, a second planetary carrier 1220, and a second sun gear 1230. The third planetary gear train 1300 may include a third ring gear 1310, a third planetary carrier 1320, and a third sun gear 1330. Finally, the fourth planetary gear train 1400 may include a fourth ring gear 1410, a fourth planetary carrier 1420, and a fourth sun gear 1430.

The system 100 may further include a plurality of control elements including brakes and clutches operatively coupled to the planetary gear trains 1100, 1200, 1300, 1400 and selectively engageable to create a set of different gear ratios between the input member 1600 and the output member 1700. In FIG. 1, the system 100 may include three brakes 1001, 1002, 1005 each of which may be connected to a housing 1500. The system 100 may include three clutches 1003, 1004, 1006 each of which may be connected between rotatable components of the system 100. The system 100 may further include a plurality of intermediate coupling members connecting components of the planetary gear trains to control elements or components of other planetary gear trains. In FIG. 1, the system 100 may include intermediate coupling members 1007, 1008, 1009, 1010, 1011. In one aspect, gears connected by any of the control elements and the intermediate coupling members may rotate at the same speed.

In FIG. 1, the planetary gear trains 1100, 1200, 1300, 1400 may be configured to obtain at least ten forward and one reverse speeds or gear ratios. The first sun gear 1130 may be selectively connected to the housing 1500 by the brake 1001. The first planetary carrier 1120 may be selectively connected to the housing 1500 by the brake 1002 and continuously connected to the second sun gear 1230 by the intermediate coupling member 1007. The first ring gear 1110 may be continuously connected to the second planetary carrier 1220 by the intermediate coupling member 1009.

The first ring gear 1110 and the secondary planetary carrier 1220 may be selectively connected to the third ring gear 1310 and to the fourth sun gear 1430 by the clutch 1004. Additionally, the first ring gear 1110 and the second planetary carrier 1220 may be selectively connected to the third sun gear 1330 by the clutch 1003. The second ring gear 1210 may be continuously connected to the third planetary carrier 1320 by the intermediate coupling member 1008.

The third planetary carrier 1320 may be selectively connected to the output member 1700 by the clutch 1006. The third sun gear 1330 may be continuously connected to the input member 1600 through the intermediate coupling member 1010. The third ring gear 1310 may be selectively connected to the clutch 1004.

The fourth sun gear 1430 may be continuously connected to the third ring gear 1310 by the intermediate coupling member 1011 and selectively connected to the clutch 1004. The fourth planetary carrier 1420 may be continuously connected to the output member 1700. The fourth ring gear 1410 may be selectively connected to the housing 1500 by the brake 1005.

In the configuration in FIG. 1, the ring gear/sun gear tooth ratio (N_{ring}/Nₛᵤₙ) of the first planetary gear train 1100 may be about 1.95. The ratio of the second planetary gear train 1200 may be about 2.62. The ratio of the third planetary gear train 1300 may be about 2.21. The ratio of the fourth planetary gear train 1400 may be about 2.15.

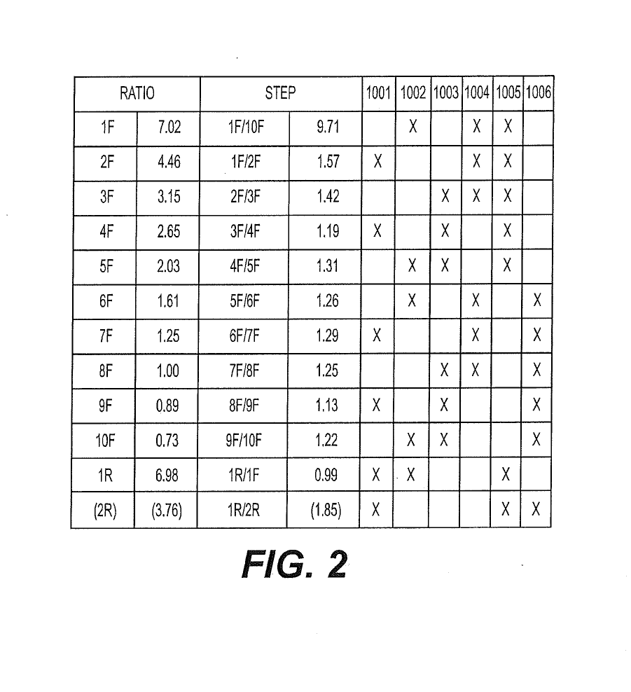

FIG. 2 shows a truth table of engagement combinations of the selectively engageable brakes, 1001, 1002, 1005 and clutches, 1003, 1004, 1006, which provide ten forward and two reverse speeds or gear ratios between the input member 1600 and the output member 1700. In the table, each of the selected brakes and clutches is denoted by the symbol, “X”.

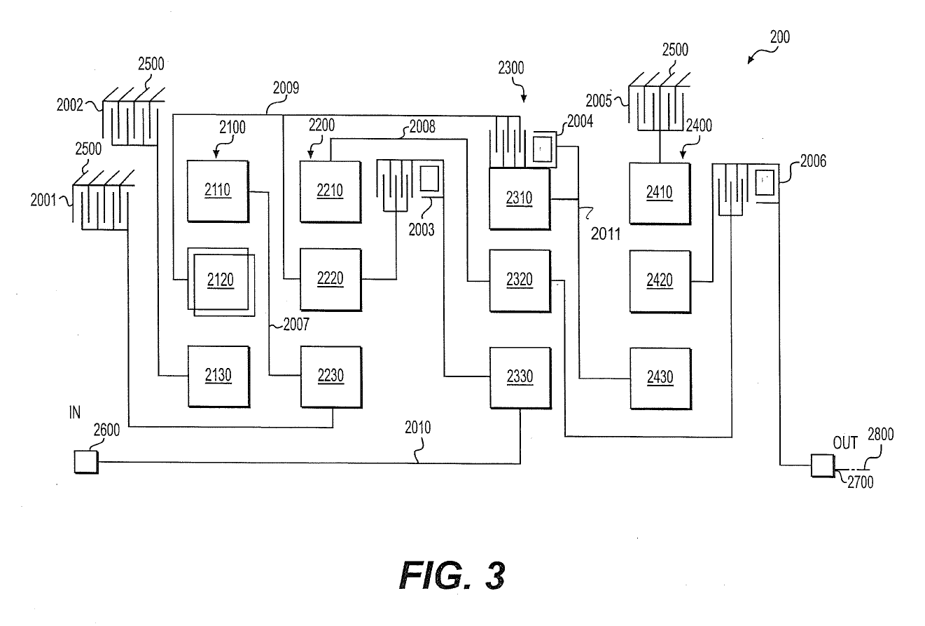

Another embodiment of the planetary multi-speed transmission system 200 is illustrated in FIG. 3. The system 200 may include four planetary gear trains 2100, 2200, 2300, 2400, which are arranged in sequential order in an axial direction or the direction of power flow along axis 2800. The first planetary gear train 2100 may include a first ring gear 2110, a first planetary carrier 2120 and a first sun gear 2130. The first planetary carrier 2120 may be a double-orbit planetary carrier. The second planetary gear train 2200 may include a second ring gear 2210, a second planetary carrier 2220, and a second sun gear 2230. The third planetary gear train 2300 may include a third ring gear 2310, a third planetary carrier 2320, and a third sun gear 2330. Finally, the fourth planetary gear train 2400 may include a fourth ring gear 2410, a fourth planetary carrier 2420, and a fourth sun gear 2430.

The system 200 may further include a plurality of control elements including brakes and clutches operatively coupled to the planetary gear trains 2100, 2200, 2300, 2400 and selectively engageable to create a set of different speeds or gear ratios between the input member 2600 and the output member 2700. In FIG. 3, the system 200 may include three brakes 2001, 2002, 2005 each of which may be connected to a housing 2500. The system 200 may include three clutches 2003, 2004, 2006 each of which may be connected between rotatable components of the system 200. The system 200 may further include a plurality of intermediate coupling members connecting components of the planetary gear trains to control elements or components of other planetary gear trains. In FIG. 3, the system 200 may include intermediate coupling members 2007, 2008, 2009, 2010, 2011. In one aspect, gears connected by any of the control elements and the intermediate coupling members may rotate at the same speed.

In FIG. 3, the gear trains 2100, 2200, 2300, 2400 may be configured to obtain at least ten forward and two reverse speeds or gear ratios. The first sun gear 2130 may be selectively connected to the housing 2500 by the brake 2002. The first planetary carrier 2120 and the second planetary carrier 2220 may be continuously connected by the intermediate coupling member 2009. The first ring gear 2110 may continuously connected to the second sun gear 2230 by the intermediate coupling member 2007.

The first planetary carrier 2120 and the secondary planetary carrier 2220 may be selectively connected to the third ring gear 2310 and to the fourth sun gear 2430 by the clutch 2004. Additionally, the first planetary carrier 2120 and the second planetary carrier 2220 may be selectively connected to the third sun gear 2330 by the clutch 2003. The second sun gear 2230 may be selectively connected to the housing 2500 by the brake 2001. The second ring gear 2210 may be continuously connected to the third planetary carrier 2320 by the intermediate coupling member 2008.

The third sun gear 2330 may be continuously connected to the input member 2600 by the intermediate coupling member 2010. The third planetary carrier 2320 may be selectively connected to the output member 2700 by the clutch 2006. The third ring gear 2310 may be selectively connected to the clutch 2004.

The fourth sun gear 2430 may be continuously connected to the third ring gear 2310 by the intermediate coupling member 2011 and selectively connected to the clutch 2004. The fourth planetary carrier 2420 may be continuously connected to the output member 2700. The fourth ring gear 2410 may be selectively connected to the housing 2500 by the brake 2005.

In the configuration in FIG. 3, the ring gear/sun gear tooth ratio (N_{ring}/Nₛᵤₙ) of the first planetary gear train 2100 may be about −2.95. The ratio of the second planetary gear train 2200 may be about 2.62. The ratio of the third planetary gear train 2300 may be about 2.21. The ratio of the fourth planetary gear train 2400 may be about 2.15.

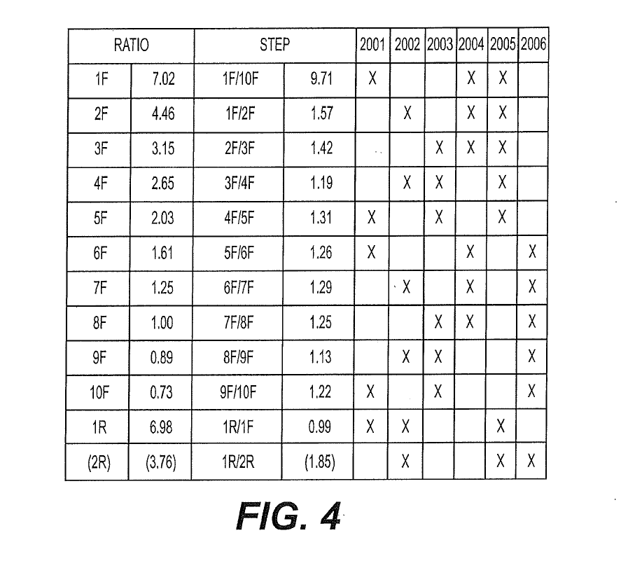

FIG. 4 shows a truth table of engagement combinations of the selectively engageable brakes, 2001, 2002, 2005 and clutches, 2003, 2004, 2006, which provide ten forward and two reverse speeds or gear ratios between the input member 2600 and the output member 2700. In the table, each of the selected brakes and clutches is denoted by the symbol, “X”.

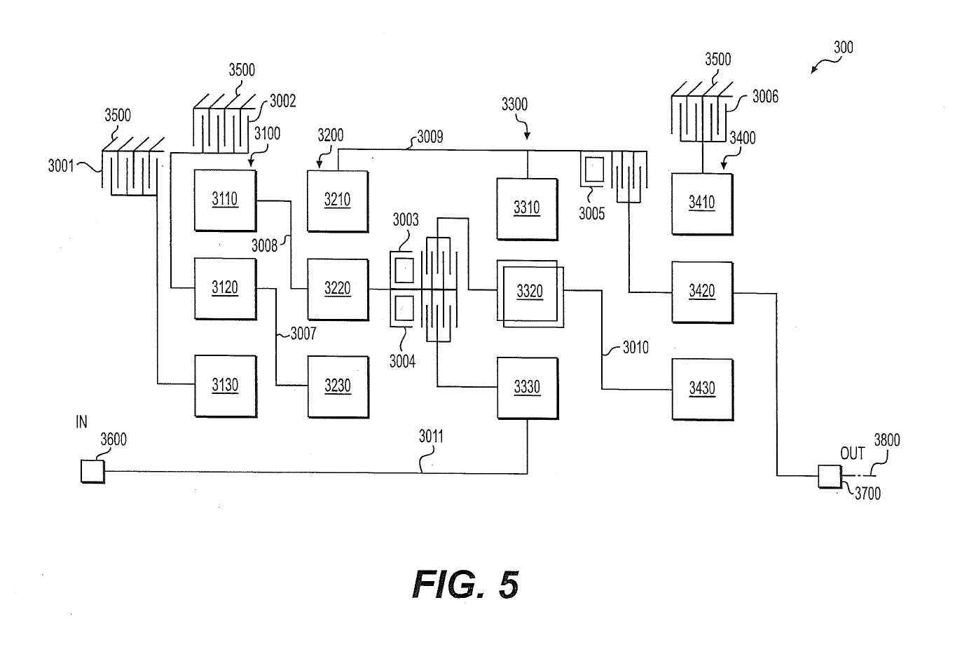

Another embodiment of the planetary multi-speed transmission system 300 is illustrated in FIG. 5. The system 300 may include four planetary gear trains 3100, 3200, 3300, 3400, which are arranged in sequential order in an axial direction or the direction of power flow along axis 3800. The first planetary gear train 3100 may include a first ring gear 3110, a first planetary carrier 3120 and a first sun gear 3130. The second planetary gear train 3200 may include a second ring gear 3210, a second planetary carrier 3220, and a second sun gear 3230. The third planetary gear train 3300 may include a third ring gear 3310, a third planetary carrier 3320, and a third sun gear 3330. Finally, the fourth planetary gear train 3400 may include a fourth ring gear 3410, a fourth planetary carrier 3420, and a fourth sun gear 3430. The third planetary carrier 3320 may be a double-orbit planetary carrier.

The system 300 may further include a plurality of control elements including brakes and clutches operatively coupled to the planetary gear trains 3100, 3200, 3300, 3400 and selectively engageable to create a set of different speeds or gear ratios between the input member 3600 and the output member 3700. In FIG. 5, the system 300 may include three brakes 3001, 3002, 3006 each of which may be connected to a housing 3500. The system 300 may include three clutches 3003, 3004, 3005 each of which may be connected between rotatable components of the system 300. The system 300 may further include a plurality of intermediate coupling members connecting components of the planetary gear trains to control elements or components of other planetary gear trains. In FIG. 5, the system 300 may include intermediate coupling members 3007, 3008, 3009, 3010, 3011. In one aspect, gears connected by any of the control elements and the intermediate coupling members may rotate at the same speed.

In FIG. 5, the first sun gear 3130 may be selectively connected to the housing 3500 by the brake 3001. The first planetary carrier 3120 may be selectively connected to the housing 3500 by the brake 3002 and continuously connected the second sun gear 3230 by the intermediate coupling member 3007. The first ring gear 3110 may be continuously connected to the second planetary carrier 3220 by the intermediate coupling member 3008.

The first ring gear 3110 and the secondary planetary carrier 3220 may be selectively connected to the third planetary carrier 3320 by the clutch 3003. Additionally, the first ring gear 3110 and the secondary planetary carrier 3220 may be selectively connected to the third sun gear 3330 by the clutch 3004. The second ring gear 3210 may be continuously connected to the third ring gear 3310 by the intermediate coupling member 3009.

The second ring gear 3210 and the third ring gear 3310 may be selectively connected to the fourth planetary carrier 3420 by the clutch 3005. The third planetary carrier 3320 may be continuously connected to the fourth sun gear 3430 by the intermediate coupling member 3010. The third planetary carrier 3320 may be a double-orbit planetary carrier. The third sun gear 3330 may be continuously connected to the input member 3600 by the intermediate coupling member 3011. The fourth planetary carrier 3420 may be continuously connected to the output member 3700. The fourth ring gear 3410 may be selectively connected to the housing 3500 by the brake 3006.

In the configuration in FIG. 5, the ring gear/sun gear tooth ratio (N_{ring}/Nₛᵤₙ) of the first planetary gear train 3100 may be about 1.95. The ratio of the second planetary gear train 3200 may be about 2.62. The ratio of the third planetary gear train 3300 may be about −3.21. The ratio of the fourth planetary gear train 3400 may be about 2.15.

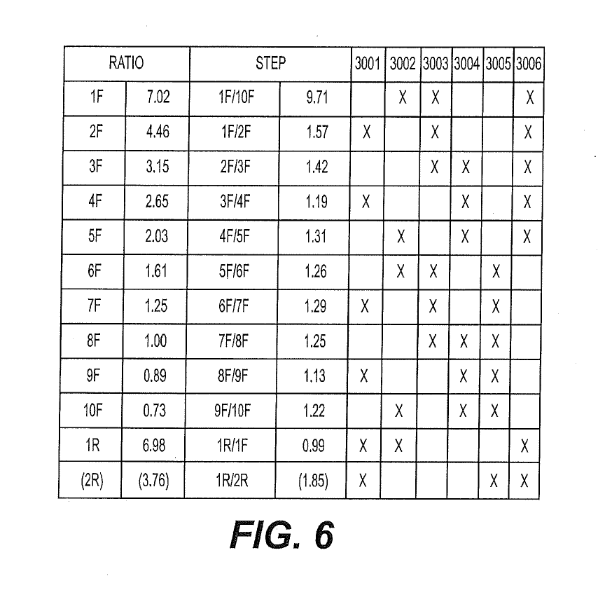

FIG. 6 shows a truth table of combinations of engagements of the selectively engageable brakes, 3001, 3002, 3006 and clutches, 3003, 3004, 3005, which provide ten forward and two reverse speed ratios between the input member 3600 and the output member 3700. In the table, each of the selected brakes and clutches is denoted by the symbol, “X”.

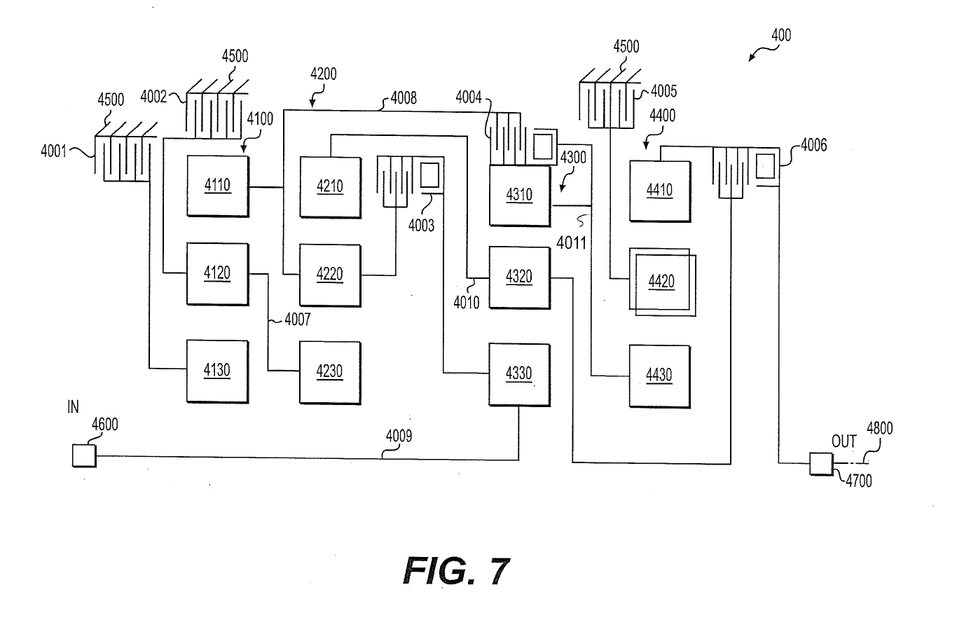

Another embodiment of the planetary multi-speed transmission system 400 is illustrated in FIG. 7. The system 400 may include four planetary gear trains 4100, 4200, 4300, 4400, which are arranged in sequential order in an axial direction or the direction of power flow along axis 4800. The first planetary gear train 4100 may include a first ring gear 4110, a first planetary carrier 4120 and a first sun gear 4130. The second planetary gear train 4200 may include a second ring gear 4210, a second planetary carrier 4220, and a second sun gear 4230. The third planetary gear train 4300 may include a third ring gear 4310, a third planetary carrier 4320, and a third sun gear 4330. Finally, the fourth planetary gear train 4400 may include a fourth ring gear 4410, a fourth planetary carrier 4420, and a fourth sun gear 4430. The fourth planetary carrier 4420 may be a double-orbit planetary carrier.

The system 400 may further include a plurality of control elements including brakes and clutches operatively coupled to the planetary gear trains 4100, 4200, 4300, 4400 and selectively engageable to create a set of different speeds or gear ratios between the input member 4600 and the output member 4700. In FIG. 7, the system 400 may include three brakes 4001, 4002, 4005 each of which may be connected to a housing 4500. The system 400 may include three clutches 4003, 4004, 4006 each of which may be connected between rotatable components of the system 400. The system 400 may further include a plurality of intermediate coupling members connecting components of the planetary gear trains to control elements or components of other planetary gear trains. In FIG. 7, the system 400 may include intermediate coupling members 4007, 4008, 4009, 4010, 4011. In one aspect, gears connected by any of the control elements and the intermediate coupling members may rotate at the same speed.

In FIG. 7, the first sun gear 4130 may be selectively connected to the housing 4500 by the brake 4001. The first planetary carrier 4120 may be selectively connected to the housing 4500 by the brake 4002 and continuously connected to the second sun gear 4230 by the intermediate coupling member 4007. The first ring gear 4110 may be continuously connected to the second planetary carrier 4220 by the intermediate coupling member 4008.

The first ring gear 4110 and the second planetary carrier 4220 may be selectively connected to the third ring gear 4310 and to the fourth sun gear 4430 by the clutch 4004. Additionally, the first ring gear 4110 and the second planetary carrier 4220 may be selectively connected to third sun gear 4330 by the clutch 4003. The second ring gear 4210 may be continuously connected to the third planetary carrier 4320 by the intermediate coupling member 4010.

The third planetary carrier 4320 may be selectively connected to the output member 4700 by the clutch 4006. The third sun gear 4330 may be continuously connected to the input member 4600 by the intermediate coupling member 4009. The third ring gear 4310 may be selectively connected to the clutch 4004.

The fourth sun gear 4430 may be continuously connected to the third ring gear 4310 by the intermediate coupling member 4011 and selectively connected to the clutch 4004. The fourth planetary carrier 4420 may be selectively connected to the housing 4500 by the brake 4005. The fourth planetary carrier 4420 may be a double-orbit planetary carrier. The fourth ring gear 4410 may be continuously connected to the output member 4700.

In the configuration in FIG. 7, the ring gear/sun gear tooth ratio (N_{ring}/Nₛᵤₙ) of the first planetary gear train 4100 may be about 1.95. The ratio of the second planetary gear train 4200 may be about 2.62. The ratio of the third planetary gear train 4300 may be about 2.21. The ratio of the fourth planetary gear train 4400 may be about −3.15.

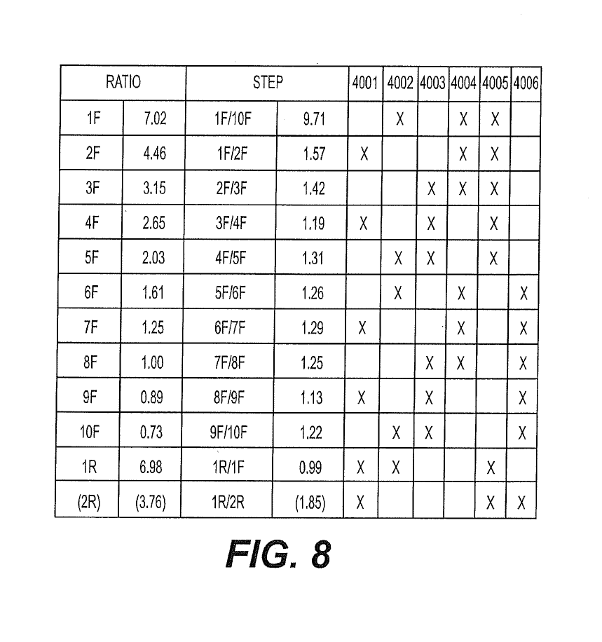

FIG. 8 shows a truth table of combinations of engagements of the selectively engageable brakes, 4001, 4002, 4005 and clutches, 4003, 4004, 4006, which provide at least ten forward and two reverse speed ratios between the input member 4600 and the output member 4700. In the table, each of the selected brakes and clutches is denoted by the symbol, “X”.

### INDUSTRIAL APPLICABILITY

A multi-speed transmission according to the disclosure may be included in a machine. For example, an input member 1600 in FIG. 1 may connect the multi-speed transmission system 100 to a power source. The power source may be of any type that outputs power in a form usable by the multi-speed transmission system 100. For example, the power source may be an internal combustion engine (such as a diesel engine, a gasoline engine a turbine engine or a natural gas engine), an electric motor, or other device capable of generating a power output.

The multi-speed transmission embodiments disclosed herein include a plurality of planetary gear assemblies and clutch arrangements that provide relatively uniform and closely spaced speed intervals that enhance performance and shift quality. The transmission having at least ten forward and one reverse speeds or gear ratios in the disclosure provides many advantages including low gear torques, low component speeds, and low drag losses while maintaining a stable performance.

As shown in an exemplary embodiment in FIG. 1, the sun gears, 1130, 1230, 1330, 1430, planetary carriers 1120, 1220, 1320, 1420 and ring gears 1110, 1210, 1310, 1410 may all rotate together simultaneously. The change in rotational speed between the input member 1600 and the output member 1700 may depend on the configuration of the sun gears, ring gears, and planetary carriers.

As an example of the operation of the embodiment of the disclosed planetary multi-speed transmission system 100, reference will now be made to FIG. 2. FIG. 2 shows the truth table for ten forward gear ratios in a range of about 7.02:1 and 0.73:1 and two reverse gear ratios in a range of about 6.98:1 and 3.76:1 of the multi-speed transmission system 100. The symbol “X” denotes selective arrangement of a particular control element.

The first forward gear (1F) may be selected by engaging the brake 1002 to connect the second sun gear 1230 to the first planetary carrier 1120 by the intermediate coupling member 1007 and further to the housing 1500. The clutch 1004 may be engaged to connect the fourth sun gear 1430 and the third ring gear 1310 to the first ring gear 1110 and the second planetary carrier 1220 by the intermediate coupling member 1009. Simultaneously, the brake 1005 may be engaged to connect the housing 1500 to the fourth ring gear 1410. The first forward gear (1F) configuration may provide a gear ratio of about 7.02.

A shift from the first forward gear (1F) to the second forward gear (2F) may be accomplished by disengaging the brake 1002 and instead engaging the brake 1001 to connect the first sun gear 1130 to the housing 1500. The clutch 1004 may remain being engaged to connect the fourth sun gear 1430 and the third ring gear 1310 to the first ring gear 1110 and the second planetary carrier 1220 by the intermediate coupling member 1009. The brake 1005 may also remain being engaged to connect the housing 1500 to the fourth ring gear 1410. The second forward gear (2F) configuration may provide a gear ratio of about 4.46. The step ratio from the first forward gear (1F) to the second forward gear (2F) in this configuration may be about 1.57.

A shift from the second forward gear (2F) to the third forward gear (3F) may be accomplished by disengaging the brake 1001 and instead engaging the clutch 1003 to connect the first ring gear 1110 and the second planetary carrier 1220 to the third sun gear 1330 and further to the input member 1600. The clutch 1004 may remain being engaged to connect the fourth sun gear 1430 and the third ring gear 1310 to the first ring gear 1110 and the second planetary carrier 1220 by the intermediate coupling member 1009. The brake 1005 may also remain being engaged to connect the housing 1500 to the fourth ring gear 1410. The third forward gear (3F) configuration may provide a gear ratio of about 3.15. The step ratio from the second forward gear (2F) to the third forward gear (3F) in this configuration may be about 1.42.

A shift from the third forward gear (3F) to the fourth forward gear (4F) may be accomplished by disengaging the clutch 1004 and instead engaging the brake 1001 to connect the first sun gear 1130 to the housing 1500 by the brake 1001. The clutch 1003 may remain being engaged to connect the first ring gear 1110 and the second planetary carrier 1220 to the third sun gear 1330 and further to the input member 1600. The brake 1005 may also remain being engaged to connect the housing 1500 to the fourth ring gear 1410. The fourth forward gear (4F) configuration may provide a gear ratio of about 2.65. The step ratio from the third forward gear (3F) to the fourth forward gear (4F) in this configuration may be about 1.19.

A shift from the fourth forward gear (4F) to the fifth forward gear (5F) may be accomplished by disengaging the brake 1001 and instead engaging the brake 1002 to connect the second sun gear 1230 to the first planetary carrier 1120 by the intermediate coupling member 1007 and further to the housing 1500. The clutch 1003 may remain being engaged to connect the first ring gear 1110 and the second planetary carrier 1220 to the third sun gear 1330 and further to the input member 1600. The brake 1005 may also remain being engaged to connect the housing 1500 to the fourth ring gear 1410. The fifth forward gear (5F) configuration may provide a gear ratio of about 2.03. The step ratio from the fourth forward gear (4F) to the fifth forward gear (5F) in this configuration may be about 1.31.

A shift from the fifth forward gear (5F) to the sixth forward gear (6F) may be accomplished by disengaging the clutch 1003 and the brake 1005 and instead engaging the clutch 1004 and the clutch 1006. The clutch 1004 may be engaged to connect the fourth sun gear 1430 and the third ring gear 1310 to the first ring gear 1110 and the second planetary carrier 1220 by the intermediate coupling member 1009. The clutch 1006 may be engaged to connect the third planetary carrier 1320 and the second ring gear 1210 to the output member 1700. The brake 1002 may remain being engaged to connect the second sun gear 1230 to the first planetary carrier 1120 by the intermediate coupling member 1007 and further to the housing 1500. The sixth forward gear (6F) configuration may provide a gear ratio of about 1.61. The step ratio from the fifth forward gear (5F) to the sixth forward gear (6F) in this configuration may be about 1.26.

A shift from the sixth forward gear (6F) to the seventh forward gear (7F) may be accomplished by disengaging the brake 1002 and instead engaging the brake 1001 to connect the first sun gear 1130 to the housing 1500 by the brake 1001. The clutch 1004 may remain being engaged to connect the fourth sun gear 1430 and the third ring gear 1310 to the first ring gear 1110 and the second planetary carrier 1220 by the intermediate coupling member 1009. The clutch 1006 may remain being engaged to connect the third planetary carrier 1320 and the second ring gear 1210 to the output member 1700. The seventh forward gear (7F) configuration may provide a gear ratio of about 1.25. The step ratio from the sixth forward gear (6F) to the seventh forward gear (7F) in this configuration may be about 1.29.

A shift from the seventh forward gear (7F) to the eighth forward gear (8F) may be accomplished by disengaging the brake 1001 and instead engaging the clutch 1003 to connect the first ring gear 1110 and the second planetary carrier 1220 to the third sun gear 1330 and further to the input member 1600. The clutch 1004 may remain being engaged to connect the fourth sun gear 1430 and the third ring gear 1310 to the first ring gear 1110 and the second planetary carrier 1220 by the intermediate coupling member 1009. The clutch 1006 may remain being engaged to connect the third planetary carrier 1320 and the second ring gear 1210 to the output member 1700. The eighth forward gear (8F) configuration may provide a gear ratio of about 1.00. The step ratio from the seventh forward gear (7F) to the eighth forward gear (8F) in this configuration may be about 1.25.

A shift from the eighth forward gear (8F) to the ninth forward gear (9F) may be accomplished by disengaging the clutch 1004 and instead engaging the brake 1001 to connect the first sun gear 1130 to the housing 1500 by the brake 1001. The clutch 1003 may remain being engaged to connect the first ring gear 1110 and the second planetary carrier 1220 to the third sun gear 1330 and further to the input member 1600. The clutch 1006 may remain being engaged to connect the third planetary carrier 1320 and the second ring gear 1210 to the output member 1700. The ninth forward gear (9F) configuration may provide a gear ratio of about 0.89. The step ratio from the eighth forward gear (8F) to the ninth forward gear (9F) in this configuration may be about 1.13.

A shift from the ninth forward gear (9F) to the tenth forward gear (10F) may be accomplished by disengaging the brake 1001 and instead engaging the brake 1002 to connect the second sun gear 1230 to the first planetary carrier 1120 by the intermediate coupling member 1007 and further to the housing 1500. The clutch 1003 may remain being engaged to connect the first ring gear 1110 and the second planetary carrier 1220 to the third sun gear 1330 and further to the input member 1600. The clutch 1006 may remain being engaged to connect the third planetary carrier 1320 and the second ring gear 1210 to the output member 1700. The tenth forward gear (10F) configuration may provide a gear ratio of about 0.73. The step ratio from the ninth forward gear (9F) to the tenth forward gear (10F) in this configuration may be about 1.22.

The first reverse gear (1R) may be selected by engaging the brake 1001, the brake 1002 and the brake 1005. The brake 1001 may be engaged to connect the first sun gear 1130 to the housing 1500. The brake 1002 may be engaged to connect the second sun gear 1230 to the first planetary carrier 1120 by the intermediate coupling member 1007 and further to the housing 1500. The brake 1005 may be engaged to connect the housing 1500 to the fourth ring gear 1410. The first reverse gear (1R) configuration may provide a gear ratio of about 6.98.

A shift from the first reverse gear (1R) to the second reverse gear (2R) may be accomplished by disengaging the brake 1002 and instead engaging the clutch 1006 to connect the fourth planetary carrier 1420, the third planetary carrier 1320 and the second ring gear 1210 to the output member 1700. The second reverse gear (2R) configuration may provide a gear ratio of about 3.76. The step ratio from the first reverse gear (1R) to the second reverse gear (2R) in this configuration may be about 1.85.

The embodiment of the planetary multi-speed transmission system 100 shown in FIG. 1 may include additional and/or alternative gear configurations and yet be within the scope of the disclosure. For example, operation of the embodiments of the planetary multi-speed transmission system 200, 300, 400 are shown in FIG. 3, FIG. 5 and FIG. 7. The corresponding truth tables are shown in FIG. 4, FIG. 6 and FIG. 8. Like the truth table of FIG. 2, described in detail herein, the truth tables of FIG. 4, FIG. 6 and FIG. 8 depict the combinations of clutches and brakes to establish ten forward and two reverse gear ratios.

The disclosure is applicable to machines that incorporate a multi-speed transmission. For example, the disclosure may be incorporated in trucks and other heavy construction and mining machines requiring certain gearing requirements met by the disclosure. It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitations as to the scope of the disclosure generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods describe herein can be performed in any suitable order unless otherwise indicated herein or otherwise clearly contradicted by context.

Accordingly, it will be apparent to those skilled in the art that various modifications and variations can be made in the disclosed transmission assemblies without departing from the scope of the disclosure. Other embodiments of the disclosed transmission will be apparent to those skilled in the art from consideration of the specification and practice of the transmission disclosed herein. It is intended that the specification and examples be considered as exemplary only, with a true scope of the disclosure being indicated by the following claims and their equivalents.

We claim:

1. A multi-speed transmission comprising:
a housing;
an input member and an output member;
four planetary gear trains comprising a first planetary gear train, a second planetary gear train, a third planetary gear train and a fourth planetary gear train, wherein each of the planetary gear trains comprises a ring gear, a planetary carrier and a sun gear; and
six control elements, wherein each of the six control elements is operatively connected to at least one of the planetary gear trains and selectively engageable to produce a set of different speeds between the input member and the output member, and wherein the set of different speeds includes ten forward speeds and two reverse speeds wherein the third planetary gear train is connected to the input member.

2. The multi-speed transmission according to claim 1, wherein the transmission is configured to engage at least three control elements at each of the speeds.

3. The multi-speed transmission according to claim 1, wherein the six control elements comprise three rotatable clutches and three brakes.

4. The multi-speed transmission according to claim 1, wherein the sun gear of the third planetary gear train is continuously connected to the input member.

5. The multi-speed transmission according to claim 1, wherein the first planetary gear train is selectively connected to at least two control elements.

6. The multi-speed transmission according to claim 1, wherein the ring gear of the third planetary gear train is connected to at least one clutch.

7. The multi-speed transmission according to claim 1, further comprising a plurality of intermediate coupling members wherein each of the intermediate coupling members is configured to be connected with at least any one of the following ring gears, planetary carriers and sun gears in the transmission.

8. A multi-speed transmission comprising:
a housing;
an input member and an output member;
four planetary gear trains comprising a first planetary gear train, a second planetary gear train, a third planetary gear train and a fourth planetary gear train wherein each of the planetary gear trains comprises a ring gear, a planetary carrier and a sun gear, wherein at least one planetary carrier in the transmission is a double-orbit planetary carrier; and
six control elements: wherein each of the control elements is operatively connected to at least one of the planetary gear trains and selectively engageable to produce a set of different speeds between the input member and the output member, wherein the set of different speeds includes ten forward speeds and two reverse speeds; and wherein the third planetary gear train is connected to the input member.

9. The multi-speed transmission according to claim 8, wherein the transmission is configured to engage at least three control elements at each of the speeds.

10. The multi-speed transmission according to claim 8, wherein the control elements comprise three rotatable clutches and three brakes.

11. The multi-speed transmission according to claim 8, wherein the sun gear of the third planetary gear train is continuously connected to the input member.

12. The multi-speed transmission according to claim 8, wherein the planetary carrier of the first planetary gear train is connected to at least one of the control elements.

13. The multi-speed transmission according to claim 8, wherein the ring gear of the third planetary gear train is connected to at least one clutch.

14. The multi-speed transmission according to claim 8, wherein the planetary carrier of the second planetary gear train is connected to at least one clutch.

15. The multi-speed transmission according to claim 8, wherein the planetary carrier of any of the first planetary gear train and the fourth planetary gear train is the double-orbit planetary carrier.

16. A multi-speed transmission comprising:
a housing;
an input member and an output member;
four planetary gear trains comprising a first planetary gear train, a second planetary gear train, a third planetary gear train and a fourth planetary gear train wherein each of the planetary gear trains comprises a ring gear, a planetary carrier and a sun gear, wherein at least one planetary carrier in the transmission is a double-orbit planetary carrier; and
no more than six control elements, wherein each of the control elements is operatively connected to at least one of the planetary gear trains and selectively engageable to produce a set of different speeds between the input member and the output member, wherein the set of different speeds includes ten forward speeds and two reverse speeds; and wherein the output member is connected the fourth planetary gear train.

17. The multi-speed transmission according to claim 16, wherein the first planetary gear train is connected to at least two of the control elements.

18. The multi-speed transmission according to claim 16, wherein the ring gear of the third planetary gear train is connected to at least one clutch.

19. The multi-speed transmission according to claim 16, further comprising a plurality of intermediate coupling members where each of the intermediate coupling members is configured to be connected with at least any one of the following ring gears, planetary carriers and sun gears in the transmission.

20. The multi-speed transmission according to claim 16, wherein the ring gear of the fourth planetary gear train is connected to at least one clutch.
